(19) United States
(12) Patent Application Publication
(10) Pub. No.: US 2021/0277857 A1
(43) Pub. Date: Sep. 9, 2021

(54) Piston Pump, in particular High-Pressure Fuel Pump for an Injection System of an Internal Combustion Engine

(71) Applicant: Robert Bosch GmbH, Stuttgart (DE)

(72) Inventor: Florian Rentz, Fellbach (DE)

(21) Appl. No.: 17/258,987

(22) PCT Filed: May 20, 2019
(86) PCT No.: PCT/EP2019/062925

§ 371 Date: Jan. 8, 2021

(30) Foreign Application Priority Data
Jul. 12, 2018 (DE) 10 2018 211 638.5

(51) Int. Cl. F02M 59/02; F04B 15/00; F04B 19/22; F04B 53/14; F02M 59/44

(52) U.S. Cl. CPC F02M 59/025; F04B 15/00; F02M 59/44; F04B 53/14; F04B 19/22

(57) ABSTRACT

A piston pump, in particular a high-pressure fuel pump for an injection system of an internal combustion engine, has a piston and a working chamber which is delimited by the piston. The piston has a running surface section, via which the piston is guided with a guide element, and is configured and developed in such a way that the running surface section of the piston tapers in cross section towards its end which faces the working chamber.

### PRIOR ART

The invention relates to a piston pump, in particular a high-pressure fuel pump for an injection system of an internal combustion engine according to the preamble of claim 1.

Such a piston pump is known from DE 10 2014 211 591 A1. This comprises a pump which is running in a pump housing for conveying and compressing fuel.

### DISCLOSURE OF THE INVENTION

The problem on which the invention is based is achieved by a piston pump with the features of claim 1.

The piston ensures in the intake phase of the piston pump (piston moves away from the working chamber) that the medium already conveyed at low pressure, for example, fuel, for example, can flow from a tank line into the working chamber (conveying chamber). In the conveying phase (piston moves toward the conveying chamber), the medium is compressed and thus brought to a higher pressure level. The medium can then be conveyed under high pressure into the rail and made available to the injection unit. Comparatively high temperatures arise on the side of the piston facing the working chamber (high-pressure side) as a result of the high compression.

The applicant has recognized that the piston is heated to a different degree over its length as a result of the high temperatures during compression. This leads to a different thermal expansion along the longitudinal piston axis. In regions under higher thermal strain, the piston increases in cross-section as a result of the thermal expansion to a greater extent than in regions under lower thermal strain. This has an influence on the play between piston and guide element which must at all times be larger than the maximum thermal expansion of the piston at the point of greatest thermal strain.

The conflict of objectives between as little as possible play which is positive for reducing leakage and the jamming of the piston is solved by optimized piston geometry. To this end, regions under higher thermal strain have a reduced diameter such that they can expand without using up the piston play. It is proposed that the piston in the region of its running surface (running surface portion or guide portion) does not have a continuously circular-cylindrical form (vertical circular cylinder), but rather tapers in cross-section (for example, in diameter) toward its end facing the working chamber.

The piston of the piston pump can be a reciprocating piston for compression of a medium (fluid), for example, fuel. The piston pump can be a high-pressure pump for the direct injection of fuel.

As already explained, it is provided that the running surface portion of the piston tapers in cross-section (diameter) toward its end facing the working chamber, therefore is tapered there in comparison with further portions of the running surface portion. In other words, the piston has in its running surface portion an outer contour which tapers toward its end facing the working chamber (reduces in terms of the external dimensions or in cross-section).

The piston is guided via its running surface portion, which can be referred to as a running surface or guide portion, by means of the guide element on or in the pump housing of the piston pump.

The piston can have several piston portions. The piston can thus have at the end facing the working chamber a compression portion for compressing the fuel in the working chamber. The running surface portion (running surface or guide portion) of the piston can adjoin this, via which the piston is guided on a guide element of the pump housing. At the end facing away from the working chamber, the piston can have an actuating portion via which the piston can be driven by means of a drive apparatus (for example, a camshaft). The compression portion and/or the actuating portion can have a reduced cross-section in comparison with the running surface portion. The piston can be formed to be rotationally symmetrical (several portions with different diameters).

Advantageous further developments are indicated in the subordinate claims. Key features of the invention are furthermore found in the following description and in the drawings.

The running surface portion (as seen in longitudinal section) can advantageously have a crowned outer contour. With this, a gradual and constant change in cross-section towards its end facing the working chamber is realized in the running surface portion. A formation of body edges in the running surface portion can thus be avoided. The outer contour of the running surface portion can be formed such that it tapers in a crowned manner at the end of the running surface portion facing away from the working chamber. A region with maximum cross-section, for example, maximum diameter, can be formed in a central region of the running surface portion, via which region the running surface portion is guided on the guide element of the piston pump. Instead of the crowned tapering at the end facing away from the working chamber of the running surface portion, the running surface portion can have a circular-cylindrical portion there. The running surface portion would then consist of a circular-cylindrical portion and a crowned portion. The circular-cylindrical portion could thus, for example, in a central region, form a transition into an outer contour (crowned portion) which tapers in a crowned manner toward the end facing the working chamber. In the case of such a configuration, the running surface portion of the piston and thus the piston overall can be guided via the circular-cylindrical portion on the guide element.

Alternatively to this, the running surface portion can have at its end facing the working chamber a conical portion (tapering conically toward the working chamber). A gradual change in cross-section is also realized with this which is easy to manufacture.

The running surface portion can expediently have a circular-cylindrical portion on the side of the conical portion facing away from the working chamber. The circular-cylindrical portion can directly adjoin the conical portion. The running surface portion of the piston can be guided via the circular-cylindrical portion and thus the piston overall can be guided on the guide element.

Alternatively to this, the running surface portion can be formed to be conical overall or in other words have a generally conical outer contour. A change in cross-section of the running surface portion which is easy to produce can also be achieved with this. To this end, the running surface portion can, as seen in longitudinal section, be formed to be trapezoidal or overall as a truncated cone (conical axis congruent to the central longitudinal axis of the piston).

In concrete terms, the guide element can have a circular-cylindrical inner surface on which the piston is guided with its running surface portion. A guide element which is easy to produce with adequate guidance properties is enabled with this.

The guide element can expediently be formed as a bushing arranged in the housing of the piston pump (inserted into the housing). The configuration of the guide element as a bushing enables an adjustment of the guide element which is flexible in terms of dimensions and material and independent of the pump housing to a piston to be used. The bushing can also be referred to as a sleeve.

It is likewise conceivable that the guide element is formed as a bore formed in the housing of the piston pump. In the case of a configuration of the guide element as a bore, the number of components of the piston pump can be reduced, as a result of which manufacture can be facilitated. A reduction in installation space in the radial direction, in relation to the central longitudinal axis of the piston, can be achieved.

Particularly preferred exemplary embodiments of the present invention are explained in greater detail below with reference to the enclosed drawing. In the drawing:

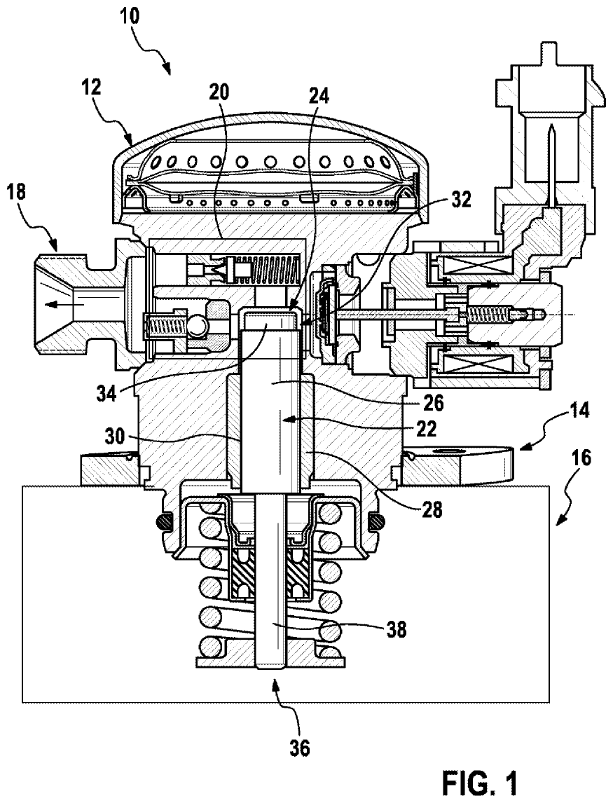

FIG. 1 shows an embodiment of a piston pump in a schematic and partially sectional side view;

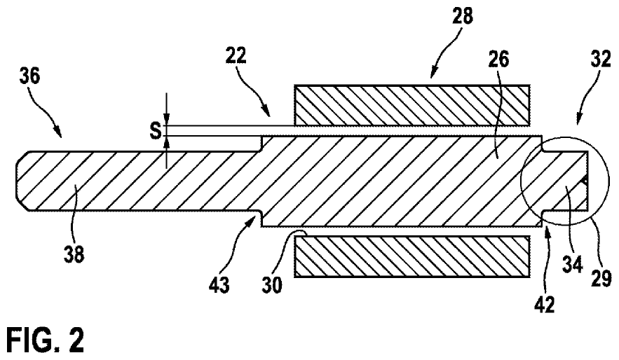

FIG. 2 shows the piston and the guide element of the piston pump from FIG. 1 in a sectional side view;

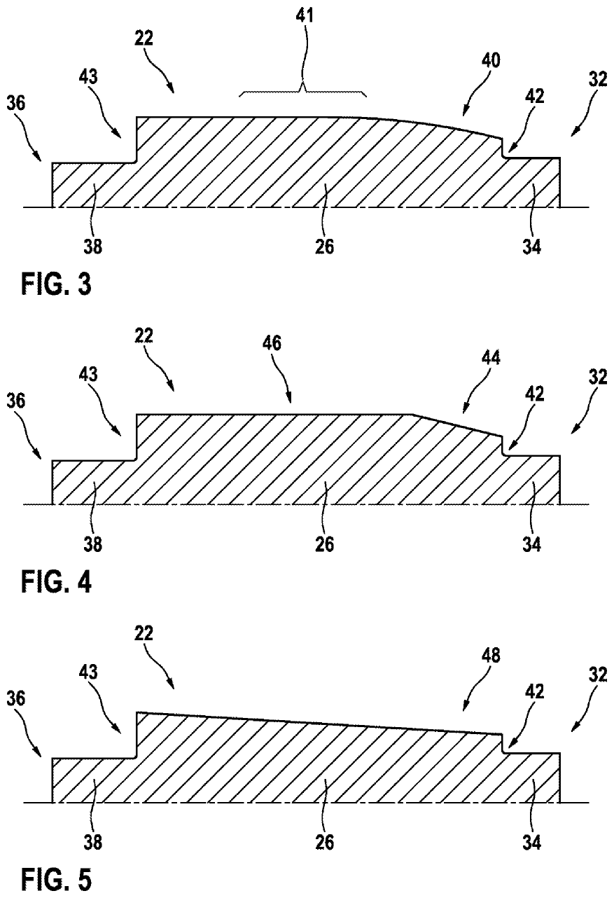

FIG. 3 shows in an enlarged and sectional side view a running surface portion, formed to be crowned, of the piston of the piston pump from FIG. 1;

FIG. 4 shows in an enlarged and sectional side view a running surface portion, formed with a conical portion, of the piston of the piston pump from FIG. 1; and

FIG. 5 shows in an enlarged and sectional side view an overall conically formed running surface portion of the piston of the piston pump from FIG. 1.

In FIG. 1, a piston pump which is formed as a high-pressure fuel pump for a fuel injection system of an internal combustion engine, not represented in greater detail, bears in general reference number 10. Piston pump 10 has a pump housing 12 and a fastening flange 14. Via fastening flange 14, piston pump 10 is fastened to a cylinder head 16, only indicated schematically here, of an internal combustion engine.

Via a port 18 arranged on pump housing 12, piston pump 10 can be joined to a rail of an injection unit (not represented) so that a medium, for example, fuel, can be made available to the injection unit under high pressure. The region marked by rectangle 20 can be referred to as a high-pressure region of piston pump 10.

Piston pump 10 has a piston 22 and a working chamber 24 which is delimited on one side by piston 22. Walls and accesses delimit working chamber 24 on further sides of working chamber 24. By means of an up and down movement—in relation to working chamber 24—of piston 22, a medium can be sucked into working chamber 24 and compressed, thus brought to a higher pressure level and then supplied to a rail of an injection unit.

Piston 22 has a running surface portion 26 via which piston 22 is guided by means of guide element 28 on pump housing 12. Guide element 28 has a circular-cylindrical inner surface 30 on which piston 22 is guided with its running surface portion 26. Guide element 28 is in the present exemplary embodiment formed as a bushing arranged in housing 12 of piston pump 10, i.e. inserted into housing 12. It is likewise conceivable that guide element 28 is embodied as a bore formed in housing 12 of piston pump 10 (not represented).

Piston 22 and guide element 28 are represented in an enlarged form on their own in FIG. 2. Guide element 28 (bushing) and piston 22 are arranged coaxially to one another, wherein a play S is produced between the outer surface of running surface portion 26 and inner surface 30 of guide element 28. The region of piston 22 under high thermal load during operation is marked by circle 29.

Piston 22 has a compression portion 34 at its end 32 facing working chamber 24 (right end in FIG. 2). Compression portion 34 adjoins running surface portion 26 and has a smaller diameter than running surface portion 26. A shoulder 42 is located between compression portion 34 and running surface portion 26.

At its end 36 facing away from working chamber 24 (left end in FIG. 2), piston 22 has an actuating portion 38 via which piston 22 can be actuated and thus driven, for example, by means of a camshaft of an internal combustion engine. Actuating portion 38 adjoins running surface portion 26 and has a smaller diameter than running surface portion 26. A shoulder 43 is located between actuating portion 38 and running surface portion 26.

Running surface portion 26 of piston 22 is tapered in cross-section towards its end 32 facing working chamber 24 (see FIGS. 3 to 5). In other words, piston 22 does not have a continuous circular-cylindrical shape in running surface portion 26, rather an outer contour which tapers toward its end 32 facing working chamber 24, i.e. an outer contour which reduces in terms of the outer dimensions or in cross-section as seen in longitudinal section.

FIG. 3 shows an embodiment of piston 22 with a running surface portion 26 which (as seen in longitudinal section) has a crowned outer contour 40. Outer contour 40 tapers from a central region 41 of running surface portion 26 continuously to its end 32 facing working chamber 24. Crowned outer contour 40 ends there in shoulder 42 between running surface portion 26 and compression portion 34. Outer contour 40 of running surface portion 26 can optionally taper from a central region 41 of running surface portion 26 also continuously toward its end 32 facing away from working chamber 24. A region with maximum cross-section, for example, with maximum diameter, can thus be formed in central region 41 of running surface portion 26, via which region running surface portion 26 is guided on guide element 28 of piston pump 10. Instead of the crowned tapering at end 36 of running surface portion 26 facing away from working chamber 24, running surface portion can have there alternatively a circular-cylindrical portion, as described above (not represented).

FIG. 4 shows an embodiment of piston 22 with a running surface portion 26 which at its end 32 facing working chamber 24 has a conical portion 44 (tapering conically toward end 32). Conical portion 44 ends in shoulder 42 between running surface portion 26 and compression portion 34. Running surface portion 26 has at side 36 of conical portion 44 facing away from working chamber 24 a circular-cylindrical portion 46. Running surface portion 26 of piston 22 and thus piston 22 can overall be guided on guide element 28 via this circular-cylindrical portion 46.

FIG. 5 shows an embodiment of piston 22 with a running surface portion 26 which is overall formed to be conical or has an overall conical outer contour 48. Outer contour 48 onto the end of running surface portion 26 facing working chamber 24 is formed to be conically tapering. Running surface portion 26 can, as seen in longitudinal section, be formed to be trapezoidal or overall as a truncated cone (cone axis of the truncated cone congruent with the central longitudinal axis of the piston). Conical portion 44 ends on one hand in shoulder 42 between running surface portion 26 and compression portion 34 and on the other hand in shoulder 43 between running surface portion 26 and actuating portion 38.

1. A piston pump, comprising:
a piston having a running surface portion;
a housing having (i) a working chamber that is delimited from the piston, and (ii) a guide element arranged and configured to guide the running surface portion of the piston,
wherein the running surface portion of the piston tapers in cross-section toward its end facing the working chamber.

2. The piston pump as claimed in claim 1, wherein the running surface portion has a crowned outer contour.

3. The piston pump as claimed in claim 1, wherein the running surface portion has a conical portion on its side facing the working chamber.

4. The piston pump as claimed in claim 3, wherein the running surface portion has a circular-cylindrical portion on the side of the conical portion facing away from the working chamber.

5. The piston pump as claimed in claim 1, wherein the running surface portion is formed overall to be conical.

6. The piston pump as claimed in claim 1, wherein the guide element has a circular-cylindrical inner surface on which the piston is guided with its running surface portion.

7. The piston pump as claimed in claim 1, wherein the guide element is formed as a bushing positioned adjacent to an interior wall of the housing of the piston pump.

8. The piston pump as claimed in claim 1, wherein the guide element is as an interior wall of the housing that defines a bore formed in the housing of the piston pump.

9. The piston pump of claim 1, wherein the piston pump is a high-pressure fuel pump for an injection system of an internal combustion engine.
